(19) United States
(12) Patent Application Publication
(10) Pub. No.: US 2018/0289175 A1
(43) Pub. Date: Oct. 11, 2018

(54) REMOTE-CONTROLLABLE FURNITURE CONTROL, FURNITURE SYSTEM AND PIECE OF FURNITURE

(71) Applicant: LOGICDATA Electronic & Software Entwicklungs GmbH, Deutschlandsberg (AT)

(72) Inventor: Stefan LUKAS, Preding (AT)

(21) Appl. No.: 15/943,641

(22) Filed: Apr. 2, 2018

(30) Foreign Application Priority Data
Apr. 3, 2017 (DE) 102017107109.1

(51) Int. Cl. A47C 31/00; G05B 15/02; A47B 9/00; A61G 7/018; A61G 7/012

(52) U.S. Cl. CPC A47C 31/008; G05B 15/02; H04W 4/80; A61G 7/018; A61G 7/012; A47B 9/00

(57) ABSTRACT

Remote-controllable furniture control (3) for a piece of furniture (15) with at least one adjustable furniture part (15, 17), wherein the furniture control (3) includes a transceiver (10), which enables both a cordless communication (1) with a first remote control device (6) according to a first transmission standard and a cordless communication (2) with a second remote control device (7) according to a different, second transmission standard.

The invention relates to a remote-controllable furniture control for a piece of furniture with at least one, preferably electrically, adjustable furniture part; the invention further relates to a piece of furniture with a furniture control and to a furniture system with such a piece of furniture and a remote control.

Pieces of furniture can include moveable parts which enable an adaption of the piece of furniture to requirements in terms of need or convenience of a user. Such pieces of furniture can for example be sickbeds or nursing beds with height-adjustable head parts and foot parts; likewise, the entire frame of the bed can be height-adjustable. Another example are height-adjustable tables. The movement of the adjustable furniture parts can be effected electrically via drives, such as electro motors or actuators. The control of these drives, so that the movement takes place in an intended manner, is effected via a furniture control. This can be controlled and operated by a user via an operating element attached to the piece of furniture or a remote control.

Though, in particular in bed systems with bed and associated remote control, wired connections between a furniture control and remote control are cost-effective and simple in installation and manufacture, they are prone to wear and damage. The wire connection is usually established through plug connections which, on the one hand, cause additional costs and, on the other hand, can become error-prone over time.

Today, bed systems are typically controlled through cordless remote controls. Wired bed systems are indeed available but are complicated in operation and seen old-fashioned.

Therefore, it is understandable that bed systems with cordless control are becoming more and more popular, and that customers favor such bed systems over bed systems with wired remote control.

When using a cordless connection, for example a radio link, between furniture control and remote control, the remote control can be laid down anywhere and the bed be operated from anywhere, provided that the remote control is located within range of the radio connection.

Cordless remote controls for bed systems are often configured as radio remote controls. Such a remote control can be a bed system-specific remote control. On the other hand, it makes sense to use existing portable devices, e.g. smartphones and tablet computers, which can establish radio connections to other devices as well.

There are a plurality of standards for data transfer via radio. Through the establishment of smartphones, in particular the Bluetooth technology for the data transmission over short distance is relevant for the bed control as well.

Manufacturers of such bed systems face the dilemma that they, on the one hand, have to add a radio remote control for one user group and, on the other hand, another user group refuses or does not need this radio remote control: this group would preferably use an already existent device, for example a smartphone or a tablet computer. Only in case of emergency, if the smartphone does not work, is there a certain willingness in this user group to fall back on the radio remote control.

The document U.S. Pat. No. 7,805,785 describes a bed system with only one radio connection. The document U.S. Pat. No. 7,979,169 describes a bed system which can be controlled both by a cell phone and by a Bluetooth remote control. In other words: both devices use the same data transmission standard. However, this comes with the disadvantage that therefore the remote control also has to be Bluetooth-compatible and thus can be more expensive in its manufacturing. In order to implement a simple radio remote control, Bluetooth is an elaborate approach, which is not necessarily required.

To please both user groups, a solution is sought which allows both applications, and thus can be manufactured with little effort and in a cost-efficient manner.

The problem is solved through a remote-controllable furniture control having the features of claim 1.

A remote-controllable furniture control for a piece of furniture with at least one adjustable furniture part includes a radio component which enables both a cordless communication according to a first transmission standard and a cordless communication according to different, second transmission standard. The communication according to the first and second transmission standard is effected with two different remote control devices. Communication is the exchange of information, i.e. data transfer for operating the furniture control, between the devices. The furniture control allows a directed influence on the piece of furniture, in particular on the adjustable furniture part. The furniture control is operated and controlled by the user by means of the remote control devices.

The presented solution enables the use of two remote control devices with different data transmission standards to move the adjustable furniture part, and to change the position thereof. The use of only one radio component, i.e. for example one single chip, for two radio communication paths is accompanied with a simplification of the furniture control.

The furniture control enables controlling a piece of furniture, for example a bed system, with a radio remote control and a Bluetooth-compatible device. Bluetooth is an industrial standard developed in the 1990s for data transmission between devices over a short distance by radio technology.

The cordless communication according to the first transmission standard can be effected with the Bluetooth-compatible device, preferably a cell phone or a tablet computer, on which a software application for furniture controlling is installed. The first transmission standard is Bluetooth in this case. Software applications, apps for short, which enable to control various functionalities for example of a bed system, can be easily implemented via smartphones. The cordless communication according to the second transmission standard can be effected with a remote control for the furniture control. Such a remote control usually has no additional functions beyond the furniture adjustment. Thus, a cheaper and simpler radio connection for the remote control than Bluetooth can be integrated in the remote control.

The cordless communication according to the first or the second transmission standard can be effected via the 2.4-GHz band, more precisely the 2.4-GHz-ISM band. This is what a frequency range is called, which can be used by high-frequency apparatuses in the industry, science, medicine, domestic or similar areas. The second transmission standard can be one of the group of Gazell, ANT, Wi-Fi and ZigBee.

The furniture control is a cost-efficient solution for the connection of two radio-based remote control devices to a piece of furniture, which both use the same 2.4-GHz-ISM band, wherein the first connection is effected via the Bluetooth standard and the second connection is effected via a standard other than Bluetooth, e.g. Gazell, ANT, Wi-Fi, ZigBee or a native standard, which enables in particular a cost-efficient manufacture of the remote control.

It is conceivable that, in the case of replacement, a remote control with a different 2.4-GHz band-based data transmission standard can be used and the hardware of the piece of furniture does not have to be replaced, but merely a software update is required, which delivers the required program code for the standard.

Advantageously, the radio component is suitable for time division multiplex transmission. First time sections are reserved for the transmission according to the first transmission standard, and second time sections are reserved for the transmission according to the second transmission standard. As a result, it is not necessary to provide an individual sender/receiver in the form of two chips or two radio components for each connection.

The furniture control can include a drive for moving the adjustable furniture part, so that it both enables communication with the remote control devices and moves the furniture part. A corresponding furniture system includes a piece of furniture with such a furniture control as well as a remote control then.

Alternatively, the furniture control can control, via a bus, at least one drive for the adjustable furniture part via a separate control for the drive. This configuration is particularly suitable for pieces of furniture with multiple adjustable furniture parts. A corresponding furniture system includes such a piece of furniture with drive and control thereof as well as a furniture control and a remote control then.

Pieces of furniture can be a bed, in particular a sickbed or nursing bed, or a table, which is height-adjustable or extendable, for example.

The invention will be described in the following with the help of the drawing.

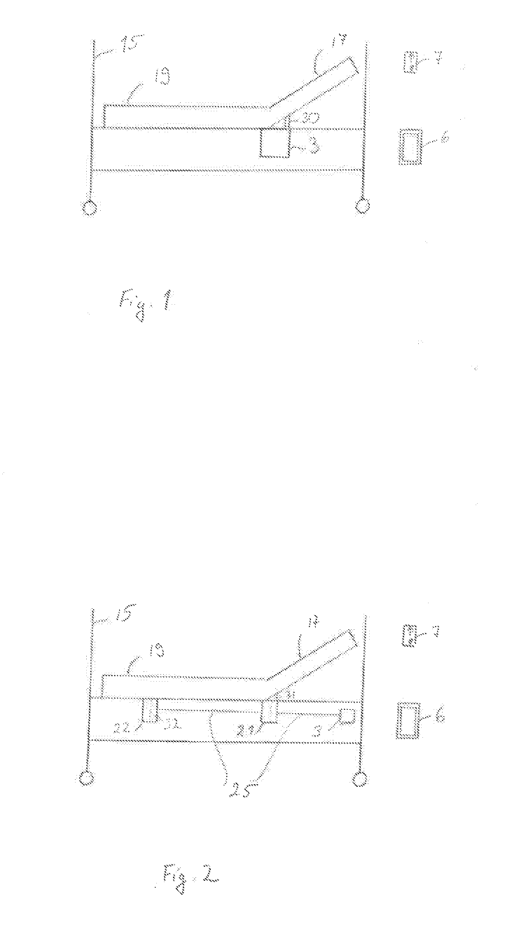

FIG. 1 shows an exemplary embodiment of a bed system.

FIG. 2 shows a further exemplary embodiment of a bed system.

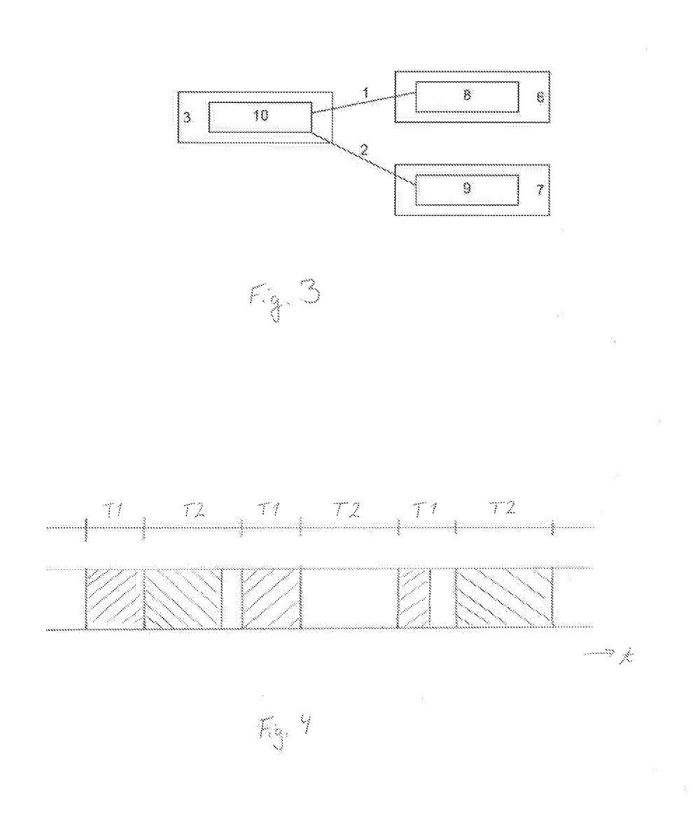

FIG. 3 schematically shows an exemplary embodiment of a furniture control.

FIG. 4 illustrates a time division multiplex method.

FIG. 1 shows a first exemplary embodiment of a bed system, which includes a sickbed 15 with height-adjustable head part 17 as an example of a piece of furniture with electrically-adjustable furniture part as well as remote control devices 7, 6 for the control thereof. The sickbed 15 can include further adjustable parts, for example a frame which is height-adjustable in its entirety, and a height-adjustable foot part. The sickbed 15 includes a furniture control 3, which can for example be mounted on the bed frame or integrated therein. The furniture control 3 includes a drive 30 for adjusting the head part 17 as well as a transceiver 10 for the communication with the remote control devices 7, 6, by means of which a user can adjust the position of the head part 17 and control the movement thereof. The drive 30 can be integrated in the furniture control 3 or have a modular structure, so that e.g. a plug connection is provided between a control module with the transceiver 10 and the drive module, and the furniture control 3 is formed by assembling the modules.

The remote control devices 6, 7 are a cell phone 6 with functionalities beyond telephony, and a remote control 7 for the bed 15. The described cell phone is also called smartphone. The remote control 7 is usually bed system-specific, i.e. it is limited in the functionality thereof substantially to the control of the bed 15. Nevertheless, further functions beyond the actual bed control, for example a little light source, can be provided in the remote control 7.

On the smartphone 6, a software application, app for short, is installed, which enables the control of the moveable bed parts 15 via the furniture control 3. Such a software application can be provided by the manufacturer of the furniture control 3 or by third parties, and is installed on the smartphone 6 of the user. The user interface of such a software application can be configured as a graphical user interface (GUI). The remote control 7, in contrast, is usually provided and delivered together with the furniture control 3. The user interface thereof may have a simpler design and comprise push buttons, for example. Advantageously, both remote control devices 6, 7 provide the same functionality with regards to the furniture control, and it is up to the user which one he uses for adjusting the head part 17. It is conceivable to use one of the remote control devices 6, 7 merely as a replacement in case of loss of the other one, or operate both of them simultaneously.

In this exemplary embodiment, the furniture control 3 is a central controller, in which the drive for the head part 17 as well as a chip as a transceiver 10 for the communication with the remote control devices 6, 7 is integrated, or which has a modular structure. Further drives can be provided at other places of the piece of furniture 15 and be connected to the furniture control 3 through wires.

FIG. 2 shows a second exemplary embodiment of a bed system which includes a sickbed 15. To avoid repetitions, only differences with respect to the preceding exemplary embodiment will be discussed in the following.

The bed system comprises multiple controls 21, 22 for drives 31, 32, which are connected to a furniture control 3 via a bus system 25. In this exemplary embodiment, drives and controls 21, 22 for head part and foot part 17, 19 of the bed 15 are provided in an exemplary manner. The furniture control 3 is configured as a module which is connectable to the bus 25. The controls 21, 22, to which the drives 31, 32 are connected, and the furniture control 3 are connected to one another via a bus 25. The data transfer between the controls 21, 22 for the drives 31, 32 and the furniture control 3 is effected through this bus. The furniture control 3 enables the communication with the remote control units 6, 7 and initiates the control of the individual controls 21, 22 via the bus 25. Such a furniture control 3 has, as a core function, the function of a radio transmitter unit 10; thus, it is responsible substantially for the communication with the remote control devices 6, 7, but also controls the controls 21, 22 via the bus 25.

It is also conceivable that a furniture control 3 is connected to a bus 25 and provides a drive for an adjustable part of the bed 15.

FIG. 3 schematically shows an exemplary embodiment of a furniture control 3 for a bed system as the above-described. The furniture control 3 comprises a combined transceiver 10 which, via two separate radio links 1, 2, can communicate with the two remote control devices 6, 7, namely a smartphone 6 which is Bluetooth-compatible, and a radio remote control 7. The remote control devices 6, 7 each have a radio component 8, 9, which serves as the transceiver thereof. The smartphone 6 has a Bluetooth transceiver, to enable a first radio link 1 with the transceiver 10 according to the Bluetooth standard. The radio component 8 is the Bluetooth transceiver mounted in the Bluetooth-compatible device. The radio remote control 7 has a radio component 9 for the communication with the transceiver 10 via a second radio link 2 according to a standard other than Bluetooth. Advantageously, this radio component 9 is a cost-efficient transceiver module for the remote control 7.

A software application is stored on the smartphone, by means of which the communication via the first radio link 1 and the control of the bed 15 is enabled.

In this exemplary embodiment, the furniture control 3 of the bed system includes a 2.4-GHz radio component. The 2.4-GHz band used is common and provides the advantage that it is permitted worldwide. In a bed system as illustrated in FIG. 1, which has a central controller as the furniture control 3, the radio component 10 is advantageously integrated in this controller. In a bed system as illustrated in FIG. 2, which can be controlled in a decentralized manner through a bus system 25, the transceiver 10 can be part of an own radio transmitter unit as the furniture control 3, which is connected to the bus system 25.

A first data transmission standard, which is supported by the radio component 10 in the furniture control 3, is Bluetooth. A second data transmission standard is Gazell, ANT, Wi-Fi, ZigBee or another standard, for example a proprietary or in-house standard.

The simultaneous communication via two different data transmission standards with the same chip is enabled by the use of a time division multiplex method.

FIG. 4 illustrates the time division multiplex method. In the time division multiplex method, the time that a channel can be used by a sender is divided into smaller sections. During the assigned section, the respective sender may transfer its data. The receiver knows the time-slots of the individual senders and can thus assign the respective data to the corresponding connections. This enables the separation of the transmitted information after receiving it.

FIG. 4 schematically shows capacity utilization of the channel by the first and second radio link 1, 2. The sections T1 were assigned to the first radio link 1, and the sections T2 were assigned to the second radio link 2. The assigned sections T1, T2 can be used completely or partially for data transmission. The capacity utilization appears with hatch.

In this exemplary embodiment, time-slots T1, T2 of different length were assigned to the radio links 1, 2, which can be caused by different transmission standards. Alternatively, it is also conceivable that the radio links 1, 2 have equally long time-slots T1, T2.

At the sender, the data is collected first, and then it is transmitted through the channel intermittently. The splitting of information into blocks is common, for example blocks of 48 bytes in ATM, byte blocks in ISDN, or bit blocks in other methods. The blocks can have different lengths.

In this exemplary embodiment, a 2.4-GHz channel is provided for the data transmission via both radio links 1, 2 in the combined transceiver 10. In the time division multiplex method, the 2.4-GHz channel is divided into time sections, in which the data transmission via 2.4-GHz radio link is performed alternately either with the first or with the second data transmission standard.

The starting time of each time section is determined through the software of the bed system. The length of the individual sections is dimensioned such that, for the user, operation of the bed system through both remote control devices is possible at the same time and no difference from a solution with two radio components for each radio link 1, 2 would be recognizable.

Through the time multiplexing, the first and the second radio links 1, 2 are established: the first radio link 1 serves for communicating with the Bluetooth-compatible device, i.e. the smartphone 6, by means of the first data transmission standard. The second radio link 2 serves for communicating with a remote control by means of the second data transmission standard. The communication between the two remote control devices 6, 7 and the transceiver 10 in the furniture control 3 can be effected either unidirectional or bidirectional via both radio links 1, 2.

Through the use of a single transceiver 10, which enables two radio links 1, 2 instead of two separate radio components for in each case one radio link, the manufacturing costs for such a bed system with two radio links 1, 2 are on the same level as of a bed system with only one radio link. At the same time, the space required on the circuit board is reduced.

The second transmission standard is selected such that a simple and cheap radio component, not an expensive Bluetooth-compatible radio component, can be used in the remote control. The transmission standard can be changed, in case of replacement, through a software update without having to change the hardware.

The features of the exemplary embodiments can be combined.

1. Remote-controllable furniture control (3) for a piece of furniture (15) comprising at least one adjustable furniture part (15, 17), wherein the furniture control (3) includes a transceiver (10), which enables a cordless communication (1) with a first remote control device (6) according to a first transmission standard and a cordless communication (2) with a second remote control device (7) according to a different, second transmission standard.

2. Furniture control (3) according to claim 1,
wherein the cordless communication (1) according to the first transmission standard is effected with a cell phone or a tablet computer, on which a software application for operating the furniture control (3) is installed, as the first remote control device (6).

3. Furniture control (3) according to claim 1,
wherein the cordless communication (2) according to the second transmission standard is effected with a remote control for the furniture control as the second remote control device (7).

4. Furniture control (3) according to claim 1,
the transceiver (10) of which is suitable for time division multiplexing, wherein first time sections (T1) are reserved for the communication (1) according to the first transmission standard, and second time sections (T2) are reserved for the communication (2) according to the second transmission standard.

5. Furniture control (3) according to claim 1,
wherein the cordless communication according to the first transmission standard and the second transmission standard is effected via the 2.4-GHz band.

6. Furniture control (3) according to claim 1,
wherein the first transmission standard is Bluetooth.

7. Furniture control (3) according to claim 1,
wherein the second transmission standard is one of a group including Gazell, ANT, Wi-Fi and ZigB ee.

8. Furniture control (3) according to claim 1,
which includes a drive (30) for adjusting the furniture part (17).

9. Furniture control (3) according to claim 1,
which is connectable to a bus (25), which enables a data transfer between the furniture control (3) and a control (21, 22) for a drive (31, 30).

10. Furniture system comprising a cordless remote control (7) and a piece of furniture (15) with at least one adjustable furniture part (15, 17) including a furniture control (3) according to claim 8.

11. Furniture system comprising a cordless remote control (7) and a piece of furniture (15) with at least one adjustable furniture part (15, 17) and at least one drive (21, 22) and a drive (31, 32) including a furniture control (3) according to claim 9.

12. Furniture system according to claim 10, wherein the piece of furniture is a bed (15) or a table.

13. Furniture system according to claim 11, wherein the piece of furniture is a bed (15) or a table.
